(19) United States
(12) Patent Application Publication
(10) Pub. No.: US 2013/0147756 A1
(43) Pub. Date: Jun. 13, 2013

(54) SYSTEMS AND METHODS FOR TOUCH PANEL SENSING AND INDICATING

(71) Applicants: Vincent Wei Chit Chan, Tai Po (HK); Jasraj Ramesh Dalvi, Bangalore (IN)

(72) Inventors: Vincent Wei Chit Chan, Tai Po (HK); Jasraj Ramesh Dalvi, Bangalore (IN)

(21) Appl. No.: 13/398,320

(22) Filed: Feb. 16, 2012

Related U.S. Application Data
(63) Continuation of application No. PCT/CN2011/083743, filed on Dec. 9, 2011.

(51) Int. Cl. G08B 7/00; G06F 3/041; G06F 3/045; G06F 3/044

(52) U.S. Cl. 345/174; 345/173

(57) ABSTRACT

One embodiment of the present invention relates to a system that includes a touch panel having a plurality of sensing pad cells each having a touch sensing element and a touch indicator element, and a controller having a plurality of input/output (I/O) pins with a dedicated I/O pin for each of the plurality of sensing pad cells. The controller is configured such that each dedicated I/O pin is configured to sample a touch sensing element of a respective sensing pad cell during a sampling time period and provide a touch indicator feedback signal to a touch indicator element of the respective sensing pad cell during a touch indication time period

### RELATED APPLICATIONS

The present invention claims priority from PCT/CN2011/083743, filed 9 Dec. 2011, herein incorporated by reference in its entirety.

### TECHNICAL FIELD

The present invention relates generally to electronics, and specifically to systems and methods for touch panel sensing and indicating.

### BACKGROUND

Touch-sensitive systems detect and respond to points of contact on one or more surfaces. A touch-sensitive system may be incorporated within an electronic device in the form of a touch panel that allows a user to both select objects or characters and receive feedback in way of an indication (e.g., a backlight) that the object or character has been selected. For example, in single button capacitive sensing touch panels, a respective light emitting diode (LED) touch indicator may be located with a given capacitive sensing element on a single sensing pad cell to provide visual feedback indication in response to touching of the given capacitive sensing element. Typically, each capacitive sensing element is coupled to a dedicated input/output (I/O) of a controller for sensing and each LED touch indicator of a single sensing pad cell are driven by dedicated I/O pin of the controller for providing touch indication.

For example, a touch screen panel with 20 capacitive sensing elements and 20 LED touch indicators requires 40 I/O ports. Therefore, increases in the number of capacitive sensing elements and the number of LED touch indicators results in larger package size to accommodate the number of I/O pads. Furthermore, an I/O pad is fixed in size and can only be located at the edge of the die. Therefore, the die has to be increased in size as the number of I/O pads increase. Also, the circuit board layout increases with complexity when the number of I/Os increase since two wires need to be connected to each single sensing pad cell.

### SUMMARY

In accordance with an aspect of the invention, a system is provided that includes a touch panel having a plurality of sensing pad cells each having a touch sensing element and a touch indicator element. The system also includes a controller having a plurality of input/output (I/O) pins with a dedicated I/O pin for each of the plurality of sensing pad cells. The controller is configured such that each dedicated I/O pin is configured to sample a touch sensing element of a respective sensing pad cell during a sampling time period and provide a touch indicator feedback signal to a touch indicator element of the respective sensing pad cell during a touch indication time period.

In accordance with another aspect of the invention, a system is provided that includes a touch panel. The system comprises a plurality of sensing pad cells each having a capacitive sensing element and a LED touch indicator and a controller having a plurality of I/O pins with a dedicated I/O pin for each of the plurality of sensing pad cells. The controller is configured such that each dedicated I/O pin is configured to sample a capacitive sensing element of a respective sensing pad cell during a sampling time period and drive a LED touch indicator of the respective sensing pad cell during a touch indication time period, wherein the controller is configured to turn on a respective LED touch indicator if the controller measures a first capacitance that indicates that a user is touching a respective sensing pad cell and the controller is configured to turn off the respective LED touch indicator if the controller measures a second capacitance that indicates that a user is not touching the respective sensing pad cell.

In accordance with an aspect of the present invention, a method for touch panel sensing and indicating is provided. The method comprises coupling a dedicated I/O pin of a controller to each of a plurality of sensing pad cells each having a touch sensing element and a touch indicator element, and configuring the controller such that each dedicated I/O pin is configured to sample a touch sensing element of a respective sensing pad cell during a sampling time period and provide a touch indicator feedback signal to a touch indicator of the respective sensing pad cell during a touch indication time period.

### BRIEF DESCRIPTION OF THE DRAWINGS

FIG. 1 illustrates an example of a system with a touch panel for touch panel sensing and indicating in accordance with an aspect of the present invention.

FIG. 2 illustrates an example waveform in which the sampled touch sensing element has indicated that a user is touching the touch panel at a location of a given sensing pad cell in accordance with an aspect of the invention.

FIG. 3 illustrates an example waveform in which the sampled touch sensing element has indicated that a user is not touching the touch panel at a location of a given sensing pad cell in accordance with an aspect of the invention.

FIG. 4 illustrates an example of another system with a touch panel for touch panel sensing and indicating in accordance with an aspect of the present invention.

FIG. 5 illustrates an example of a plurality of sensing pad cell time cycles each having a sampling time period and a touch indication time period in accordance with an aspect of the invention.

FIG. 6 illustrates an example of a method for touch panel sensing and indicating in accordance with an aspect of the present invention.

### DETAILED DESCRIPTION

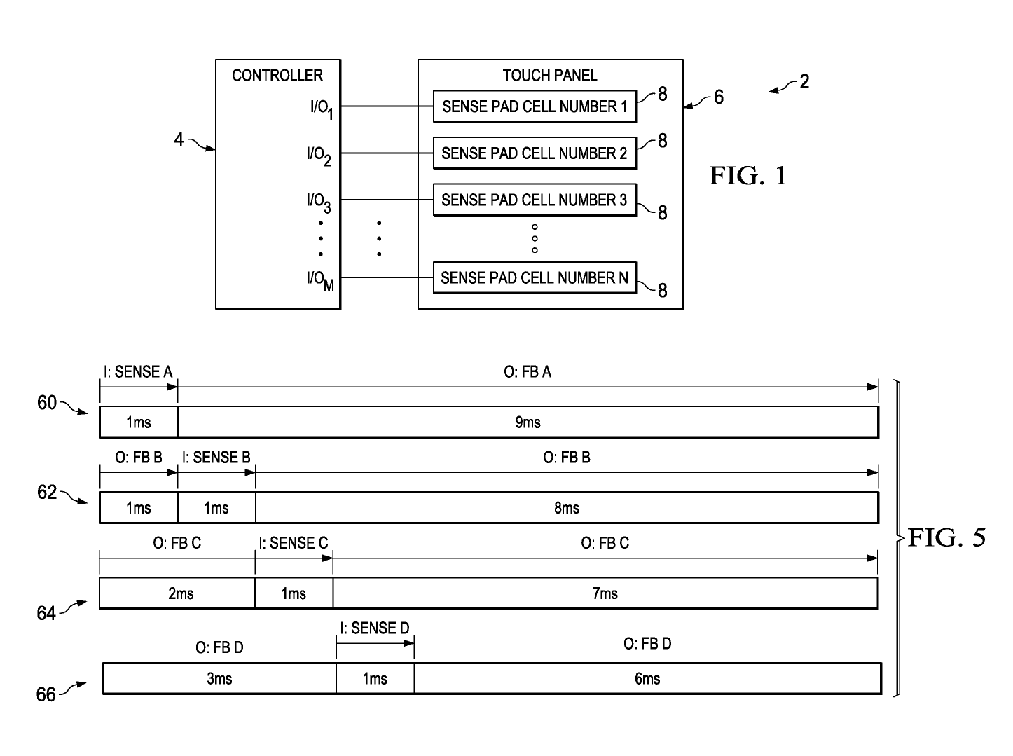

FIG. 1 illustrates an example of a system 2 (e.g., a computer, a tablet, a phone, a camera etc.) with a touch panel 6 for touch panel sensing and indicating in accordance with an aspect of the present invention. The system 2 includes a controller 4 that is configured or programmed to sample a given touch panel sensing element and to provide a touch indicator feedback signal to a touch indicator element of a given sensing pad cell for each of a plurality of sensing pad cells 8 (labeled sensing pad cells #1-N, where N is an integer greater than one) of the touch panel 6. The touch panel sensing elements can be, for example, resistive, capacitive, or employ surface wave technology. The touch indicator element can be the type that provides user touch feedback, for example, via light, vibration, sound or other form of user touch feedback. It is to be appreciated that the number of sensing pad cells 8 can be based on a specific design criteria and density of the touch panel 6.

The controller includes a plurality of input/output (I/O) pins labeled, I/O₁ through I/O_{M}, where M is an integer greater than one. A given single I/O pin is coupled and dedicated to a given sensing pad cell to both sample as input a touch sensing element of the given sensing pad cell over a sampling time period and to provide as output a touch indicator feedback signal to a touch indicator element of the given sensing pad cell over a touch indication time period based on the sampled touch sensing element. The sampling time period and the touch indication time period define a sensing pad cell cycle time. The controller multiplexes through sampling and providing touch indicator feedback signals for each of the plurality of sense pad cells.

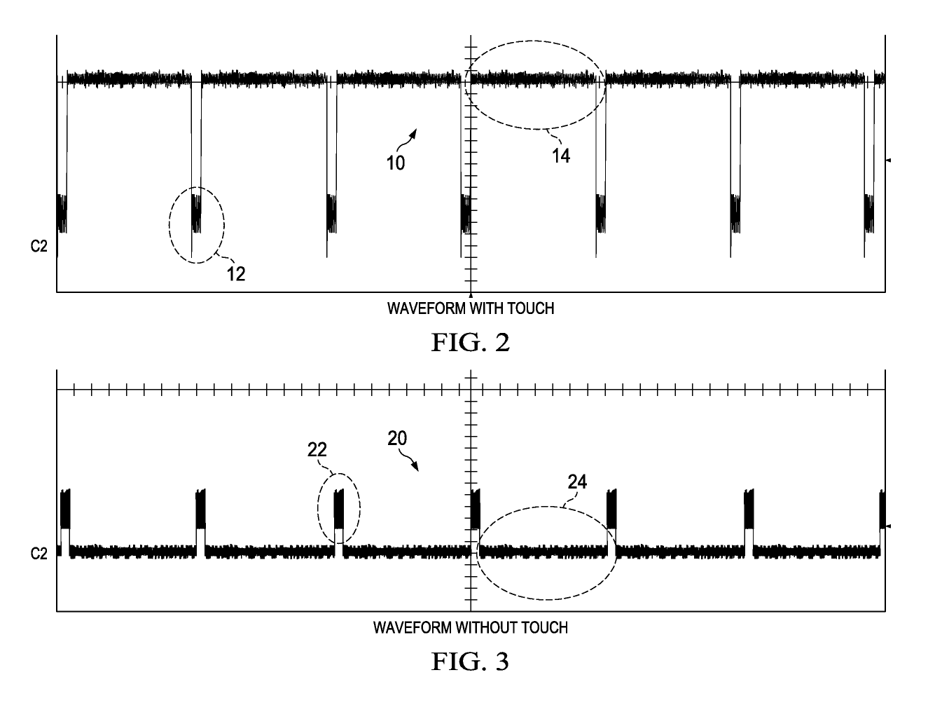

FIG. 2 illustrates an example waveform 10 in which the sampled touch sensing element has indicated that a user is touching the touch panel at a location of a given sensing pad cell. As illustrated in the waveform 10, each of sampling time periods 12 are followed by respective touch feedback indication time periods 14. In the waveform 10, the output pin is set in a high state causing a respective touch indicator to provide touch feedback to a user. FIG. 3 illustrates an example waveform 20 in which the sampled touch sensing element has indicated that a user is not touching the touch panel at a location of the given sensing pad cell. As illustrated in the waveform 20, each of touch sensing element sampling time periods 22 are followed by respective touch feedback indication time periods 24. In the waveform 20, the output pin is in a low state resulting in the respective touch indicator not providing feedback to a user.

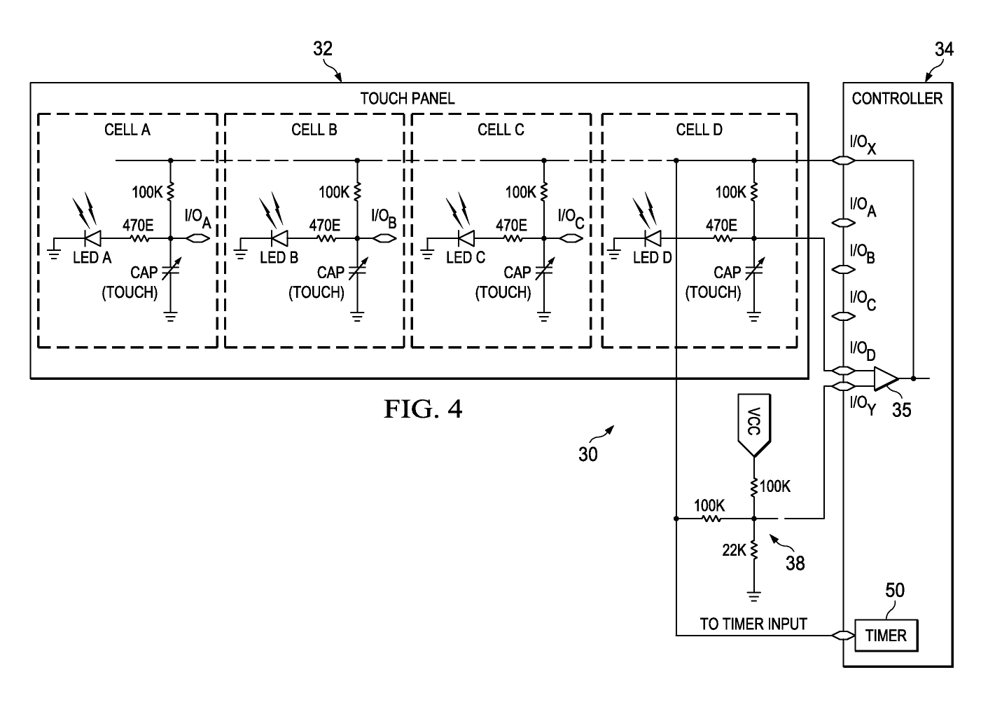

FIG. 4 illustrates another example of a system 30 (e.g., a computer, a tablet, a phone, a camera etc.) with a touch panel 32 for touch panel sensing and indicating in accordance with an aspect of the present invention. The system 30 includes a controller 34 that is configured or programmed to sample a given capacitive sensing element and to drive and associated LED touch indicator of a given sensing pad cell for each of a plurality of sensing pad cells (labeled sensing pad cells A-D in FIG. 4) of the touch panel 32. It is to be appreciated that the present example shows four sensing pad cells (A-D) for illustrative purposes, and that the system can have a much larger number of sensing pad cells (e.g., 20-200) based on a size and density of the touch panel. A single input/output (I/O) pin (I/O_{A-D}) is coupled to a given sensing pad cell to both sample a capacitance of a capacitive sensing element of the given sensing pad cell over a sampling time period and to drive the LED touch indicator of the given sensing pad cell over a touch indication time period based on the sampled capacitance of the associated capacitive sensing element. The sampling time period and the touch indication time period define a sensing pad cell cycle time. In the present example, the controller multiplexes sampling of capacitive sensing elements and driving LED touch indicators over the plurality of sensing pad cells (Cells A-D).

For example, as illustrated in FIG. 5, a first cycle time 60 includes a 1 ms capacitance sampling time period for sampling capacitance sensing element A in which I/O pin I/O_{A} is configured as an input pin and a 9 ms touch indication time period for either turning on or off LED touch indicator A based on the sampled capacitance of capacitance sensing element A in which I/O pin I/O_{A} is configured as an output pin. A second cycle time 62 begins after the 1 ms capacitance sampling time period for sampling capacitance sensing element A. The second cycle time 62 includes a 1 ms capacitance sampling time period for sampling capacitance sensing element B in which I/O pin I/O_{B} is configured as an input pin and a 9 ms touch indication time period for either turning on or off LED touch indicator B based on the sampled capacitance of capacitance sensing element B in which I/O pin I/O_{B} is configured as an output pin. A third cycle time 64 begins after the 1 ms capacitance sampling time period for sampling capacitance sensing element B with the same sampling time period and the same touch indication time period for capacitance sensing element C and LED touch indicator C. A fourth cycle time 66 begins after the 1 ms capacitance sampling time period for sampling capacitance sensing element C with the same sampling time period and the same touch indication time period for capacitance sensing element D and LED touch indicator D. The entire operation of capacitance sampling and turning on or off LED touch indicators continuously repeats and cycles through sensing pad cells A-D.

Referring again to FIG. 4 in the illustrated example, the controller 34 is configured or programmed to sample capacitance sensing element D during a capacitance sampling time period. The controller sets I/O_{D} pin to be coupled to a first input of a comparator 35 and a I/O_{Y} pin to be coupled to a second input of the comparator 35 inside the controller 34. The I/O_{Y} pin is connected to a ladder network 38 that fixes a reference voltage of the comparator 36 at a voltage that assures that a respective LED touch indicator (LED touch indicator D in the present illustration) does not illuminate during the capacitance sampling time period. The ladder network 38 includes a 100K resistor and 22K resistor voltage divider coupled between a voltage supply (VDD) and ground. The ladder network 38 also includes a 100K resistor coupled to a common node of the resistor voltage divider and an I/O_{X} pin of the controller 34.

The I/O_{X} pin of the controller 34 is internally coupled to the output of the comparator 36. Each of the sensing pad cells include a 100K resistor coupled on one end to the I/O_{X} pin and a second end to a capacitance sensing element coupled to ground. Each of the sensing pad cells also include a 470 ohm resistor coupled between a common node of the 100K resistor and capacitive sensing element and a LED touch indicator coupled to ground. The comparator 36, the ladder network 38, the 100K resistor and capacitive sensing element arrangement is configured as an oscillator such that the present example employs a relaxation oscillation method. The output of the comparator 36 at the I/O_{X} pin is coupled to an input of a timer 50. The timer 50 increments based on the frequency of the oscillator. The frequency changes due to the capacitance of the capacitance sensing element changing in response to a touch of a user at the sensing pad cell location. The timer 50 and thus the controller 34 then can determine different counts corresponding to different output frequencies when the sensing pad cell is being touched and when the sensing pad cell is not being touched.

After the capacitance sampling time period, the controller 34 enters the LED driving time period and reconfigures or programs the I/O_{D} pin to an output pin and either turns on the LED touch indicator D by setting a high logic on the I/O_{D} pin or turns off the LED touch indicator D by setting a low logic on the I/O_{D} pin based on the determined sampled capacitance. The controller 34 multiplexes over to the I/O_{A} pin to sample the capacitance sensing element A over a capacitance sampling period and turning on or off LED touch indicator A by setting a high logic or low logic, respectively, on the I/O_{A} pin. The controller 34 also multiplexes over to the I/O_{B} pin to sample the capacitance sensing element B and turning on or off LED touch indicator B and multiplexes over to the I/O_{C} pin to sample the capacitance sensing element C and turning on or off LED touch indicator C. The controller 34 continuously repeats the multiplexing, sampling and turning on or off process.

It is to be appreciated that the system 30 could have a variety of other components, such as a central processing unit (CPU), I/O devices, communication devices, display drivers, etc. that are typically found in touch panel systems. Furthermore, the controller 34 illustrated in FIG. 4, is only an example of a controller that could be employed to sample capacitive sensing elements and to turn on or off LED touch indicators with single dedicated I/O pins per sensing pad cell, and that a variety of other types of controllers and/or circuitry can be employed to carry out the present invention. Furthermore, FIG. 4 is only one possible example of measuring a touch sensing element and a variety of other structural and functional configurations could be employed to carry out the present invention.

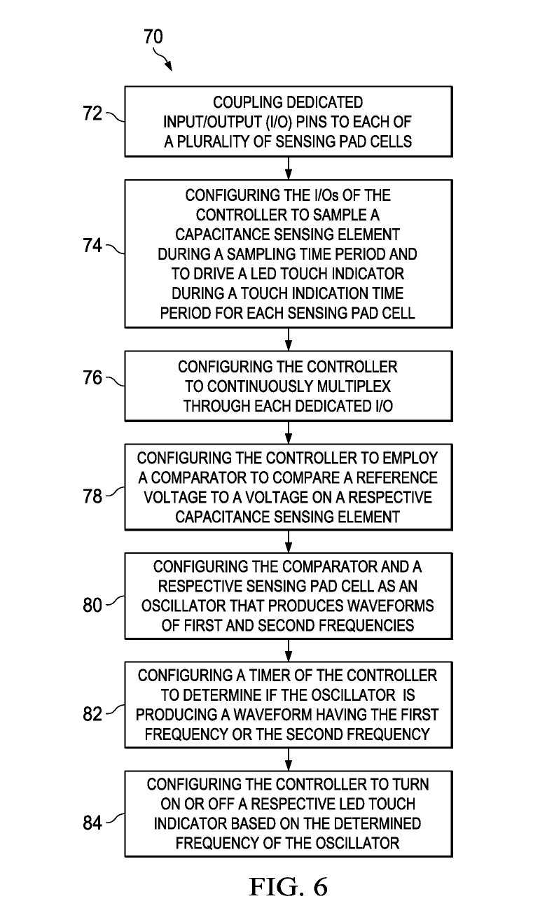

In view of the foregoing structural and functional features described above, certain methods will be better appreciated with reference to FIG. 6. It is to be understood and appreciated that the illustrated actions, in other embodiments, may occur in different orders and/or concurrently with other actions. Moreover, not all illustrated features may be required to implement a method.

FIG. 6 illustrates an example of a method 70 for touch panel sensing and indicating in accordance with an aspect of the present invention. The method 70 begins at 72 where dedicated input/output (I/O) pins of a controller are coupled to respective sensing pad cells for each of a plurality of sensing pad cells. Each of the sensing pad cells includes a capacitive sensing element and a LED touch indicator. At 74, the controller is configured such that each dedicated I/O pin is configured to sample a capacitive sensing element of a respective sensing pad cell during a sampling time period and drive a LED touch indicator of the respective sensing pad cell during a touch indication time period. At 76, the controller is configured to continuously multiplex through sampling capacitive sensing elements and driving LED touch indicators through dedicated I/O pins for each of the plurality of sensing pad cells. At 78, the controller is configured to employ a comparator to compare a reference voltage to a voltage on a respective capacitive sensing element to determine if a user is touching a respective sensing pad cell or not touching a respective sensing pad cell for each of the plurality of sensing pad cells. The methodology then proceeds to 80.

At 80, the comparator and the sensing pad cell is configured as an oscillator that produces a waveform having a first frequency when a user is touching a respective sensing pad cell and the oscillator produces a waveform having a second frequency when a user is not touching the respective sensing pad cell. At 82, a timer of the controller is configured to determine if the oscillator is producing a waveform having the first frequency or the second frequency. At 84, the controller is configured to turn on or off a respective LED touch indicator based on the determined frequency of the waveform.

What have been described above are examples of the invention. It is, of course, not possible to describe every conceivable combination of components or method for purposes of describing the invention, but one of ordinary skill in the art will recognize that many further combinations and permutations of the invention are possible. Accordingly, the invention is intended to embrace all such alterations, modifications, and variations that fall within the scope of this application, including the appended claims.

What is claimed is:

1. A system comprising:
a touch panel having a plurality of sensing pad cells each having a touch sensing element and a touch indicator element; and
a controller having a plurality of input/output (I/O) pins with a dedicated I/O pin for each of the plurality of sensing pad cells, the controller being configured such that each dedicated I/O pin is configured to sample a touch sensing element of a respective sensing pad cell during a sampling time period and provide a touch indicator feedback signal to a touch indicator element of the respective sensing pad cell during a touch indication time period.

2. The system of claim 1, wherein the touch sensing element is a capacitive sensing element and the touch indicator element is a light emitting diode (LED).

3. The system of claim 2, wherein the controller is configured to turn on a respective LED touch indicator if the controller measures a first capacitance that indicates that a user is touching a respective sensing pad cell and the controller is configured to turn off the respective LED touch indicator if the controller measures a second capacitance that indicates that a user is not touching the respective sensing pad cell.

4. The system of claim 2, wherein the controller is configured to compare a reference voltage to a voltage on a respective capacitive sensing element to determine if a user is touching a respective sensing pad cell or not touching a respective sensing pad cell.

5. The system of claim 4, the reference voltage being set by a ladder network such that a respective LED touch indicator of the respective sensing pad cell does not turn on during the sampling time period.

6. The system of claim 4, wherein the controller is configured to employ a comparator to compare the reference voltage to a voltage on the respective capacitive sensing element, the comparator and the sensing pad cell being configured as an oscillator that produces a waveform having a first frequency when a user is touching a respective sensing pad cell and the oscillator produces a waveform having a second frequency when a user is not touching the respective sensing pad cell.

7. The system of claim 6, wherein an output of the comparator is provided to a timer that is employed to determine if the oscillator is producing a waveform having the first frequency or the second frequency, such that the controller can determine to turn on or off a respective LED touch indicator based on the determined frequency of the waveform.

8. The system of claim 1, wherein the touch sensing element is one of a capacitive sensing element, a resistive sensing element and a surface wave element and the touch indicator element is one of a light emitting diode (LED), a vibration producing element or a sound producing element.

9. The system of claim 1, wherein the controller is configured to continuously multiplex through sampling touch sensing elements and providing touch indicator feedback signals to touch indicator elements for each of the plurality of sensing pad cells.

10. A system having a touch panel, the system comprising:
a plurality of sensing pad cells each having a capacitive sensing element and a light emitting diode (LED) touch indicator;
a controller having a plurality of input/output (I/O) pins with a dedicated I/O pin for each of the plurality of sensing pad cells, the controller being configured such that each dedicated I/O pin is configured to sample a capacitive sensing element of a respective sensing pad cell during a sampling time period and drive a LED touch indicator of the respective sensing pad cell during a touch indication time period, wherein the controller is configured to turn on a respective LED touch indicator if the controller measures a first capacitance that indicates that a user is touching a respective sensing pad cell and the controller is configured to turn off the respective LED touch indicator if the controller measures a second capacitance that indicates that a user is not touching the respective sensing pad cell.

11. The system of claim 10, wherein the controller is configured to continuously multiplex through sampling capacitive sensing elements and driving LED touch indicators for each of the plurality of sensing pad cells.

12. The system of claim 11, wherein the controller is configured to employ a comparator to compare a reference voltage to a voltage on a respective capacitive sensing element to determine if a user is touching a respective sensing pad cell or not touching a respective sensing pad cell, the reference voltage being set such that a respective LED touch indicator of the respective sensing pad cell does not turn on during the sampling time period.

13. The system of claim 12, wherein the controller is configured to employ a comparator to compare the reference voltage to a voltage on the respective capacitive sensing element, the comparator and the sensing pad cell being configured as an oscillator that produces a waveform having a first frequency when a user is touching a respective sensing pad cell and the oscillator produces a waveform having a second frequency when a user is not touching the respective sensing pad cell.

14. The system of claim 13, wherein an output of the comparator is provided to a timer that is employed to determine if the oscillator is producing a waveform having the first frequency or the second frequency, such that the controller can determine to turn on or off a respective LED touch indicator based on the determined frequency of the waveform.

15. The system of claim 14, wherein the sampling time period and the driving time period form a sensing pad cell cycle time that is repeated for each of the plurality of sensing pad cells and the sampling time period is substantially smaller than the driving time period for every sensing pad cell cycle time.

16. A method for touch panel sensing and indicating, the method comprising:
coupling dedicated input/output (I/O) pins of a controller to respective sensing pad cells for each of a plurality of sensing pad cells each having a touch sensing element and a touch indicator element; and
configuring the controller such that each dedicated I/O pin is configured to sample a touch sensing element of a respective sensing pad cell during a sampling time period and provide a touch indicator feedback signal to a touch indicator element of the respective sensing pad cell during a touch indication time period.

17. The method of claim 16, further comprising configuring the controller to continuously multiplex through sampling touch sensing elements and providing touch indicator feedback signals to touch indicator elements through dedicated I/O pins for each of the plurality of sensing pad cells.

18. The method of claim 16, further comprising configuring the controller to employ a comparator to compare a reference voltage to a voltage on a respective touch sensing element to determine if a user is touching a respective sensing pad cell or not touching a respective sensing pad cell for each of the plurality of sensing pad cells.

19. The method of claim 18, further comprising configuring the controller to employ a comparator to compare the reference voltage to a voltage on the respective touch sensing element, the comparator and the sensing pad cell being configured as an oscillator that produces a waveform having a first frequency when a user is touching a respective sensing pad cell and the oscillator produces a waveform having a second frequency when a user is not touching the respective sensing pad cell.

20. The method of claim 19, further comprising configuring a timer of the controller to determine if the oscillator is producing a waveform having the first frequency or the second frequency, and configuring the controller to turn on or off a respective touch indicator element based on the determined frequency of the waveform.
